(19) United States
(12) Patent Application Publication
(10) Pub. No.: US 2005/0276670 A1
(43) Pub. Date: Dec. 15, 2005

(54) Apparatus and methods for holding and actuating power tools

(76) Inventor: Scott Freund, McHenry, IL (US)

Correspondence Address: GROSSMAN & FLIGHT LLC, Suite 4220, 20 North Wacker Drive, Chicago, IL, 60606-6357, US

(21) Appl. No.: 10/867,938

(22) Filed: Jun. 15, 2004

(51) Int. Cl. B23B 47/18

(52) U.S. Cl. 408/129

(57) ABSTRACT

Apparatus and methods for holding and actuating power tools are disclosed. An example inverted power tool press includes a frame, a tool support, and a base. The tool support is mechanically coupled to the frame and configured to support a power tool. The base is mechanically coupled to the frame so that a cutting end of the power tool is configured to move in a direction that is substantially opposite the base to engage a work surface during operation.

### FIELD OF THE DISCLOSURE

The present disclosure relates generally to power tools and, more particularly, to apparatus and methods for holding and actuating power tools.

### BACKGROUND

Power tools are typically manufactured as either handheld power tools or stationary power tools. For example, power drills may be manufactured as handheld power drills or stationary drill presses. Handheld power drills are particularly useful for on-site jobs such as, for example, building construction sites because of their capability to be easily carried from one location to another. Handheld power tools such as, for example, the handheld power drill are characterized by their portability and adaptability to different operating positions. For example, handheld power drills can be easily adapted to drill holes in any direction. During operation, an operator (i.e., a person) holds the handheld power drill in any desired orientation such as, for example, in a downward orientation, a lateral orientation, a diagonal orientation, an upward orientation, etc. for drilling a desired hole into a desired location.

In contrast, stationary drill presses are designed to remain in one location and to drill holes in a generally downward direction. In general, stationary drill presses are intentionally designed to be large and heavy for maintaining stability during operation. As a result of their large and heavy design, stationary drill presses are generally intended to remain in one location such as, for example, a machine shop, a woodworking shop, etc. Stationary drill presses are typically used for working on material (i.e., work pieces) that can be moved onto and off the stationary drill press.

The function of a drill press is sometimes needed for working at on-site jobs or for working on pieces that are not movable on and off the stationary drill press. One example apparatus that has been designed to address this need is a portable drill press kit. Portable drill press kits are typically much smaller than drill presses and are configured to hold a handheld power drill so that the drill bit end points in a generally downward direction. Portable drill press kits are designed to be assembled and disassembled at work sites to combine portability and stationary drill press functionality. In general, portable drill press kits include a base, a stand, and a power drill holding fixture. The holding fixture is mechanically coupled to the stand, which is supported by the base. In some cases, the base is magnetic, which serves to secure the base of the portable drill press kit onto ferrous materials (e.g., iron, steel, etc.), thus providing stability during operation.

Portable drill press kits are very useful for a limited number of applications. For example, portable drill press kits are typically limited to applications that require drilling in a generally downward direction. Portable drill press kits having magnetic bases have further limitations. For example, magnetic bases limit some portable drill press kits to drilling into work surfaces (e.g., a surface to be drilled) of ferrous work pieces. In addition, magnetic bases limit the amount of force that can be applied to a drill during operation to the force of attraction between the magnetic base and the ferrous work piece.

Many on-site jobs require holes in places that are not easily accessible by portable drill press kits. One such example includes drilling into overhead work surfaces such as ceilings, overhead beams, door frames, etc., which requires a worker to hold a drill in an overhead position for extended periods of time. Unfortunately, portable drill press kits are not adequately adaptable to overhead drilling. In some case, where overhead work surfaces are a ferrous material, a portable drill press kit having a magnetic base may be used. However, using the portable drill press kit in this manner is cumbersome and often prone to failure. More specifically, the amount of driving force that can be used to drive a drill bit into a work surface is greatly reduced due to the gravitational force that is working to pull the magnetic base from the work surface. In this configuration, applying excess force to the portable drill press kit will cause the magnetic base to separate from the work surface.

Typically, an operator (i.e., a person) must perform overhead drilling jobs by manually supporting a drill. Overhead drilling jobs typically require many overhead holes that require a long time duration to drill. This can be a very tiring process and, in turn, inefficient due to the number and length of resting periods required to recover from holding the drill in the overhead position. In addition, overhead drilling may be dangerous due to the unstable position in which a person must stand to perform the job.

### BRIEF DESCRIPTION OF THE DRAWINGS

FIG. 1 is an elevational view of a known example handheld power tool.

FIG. 2 is an elevational view of an example disclosed inverted drill press.

FIGS. 3, 4, and 5 are elevational views of example inverted drill presses used in various example applications and which may be implemented using the example inverted drill press of FIG. 2.

FIGS. 6A, 6B, and 6C illustrate various views of an example tool fixture that may be used with any of the example inverted drill presses of FIGS. 2 through 5.

FIGS. 7A, 7B, and 7C illustrate various views of a second example tool fixture that may be used with any of the example inverted drill presses of FIGS. 2 through 5.

FIGS. 8A, 8B, and 8C illustrate various views of a third example tool fixture that may be used with any of the example inverted drill presses of FIGS. 2 through 5.

FIG. 9A illustrates a plan view and FIG. 9B illustrates a cross-sectional view of an example height adjustment apparatus that may be used with any of the example inverted drill presses of FIGS. 2 through 5.

FIG. 10A illustrates a plan view and FIG. 10B illustrates a cross-sectional view of a second example height adjustment apparatus that may be used with any of the example inverted drill presses of FIGS. 2 through 5.

FIG. 11A illustrates a plan view and FIG. 11B illustrates a cross-sectional view of a third example height adjustment apparatus that may be used with any of the example inverted drill presses of FIGS. 2 through 5.

FIGS. 12A, 12B, and 12C illustrate various views of the example actuator of the example inverted drill press of FIG. 2.

FIG. 13 illustrates an elevational view of a second example actuator that may be used with any of the example inverted drill presses of FIGS. 2 through 5.

FIG. 14 illustrates an elevational view of an example trigger actuator that may be used with any of the example inverted drill presses of FIGS. 2 through 5.

FIG. 15 illustrates an exploded isometric view of various example assembly configurations that may be used to assemble any of the example inverted drill presses of FIGS. 2 through 5.

### DETAILED DESCRIPTION

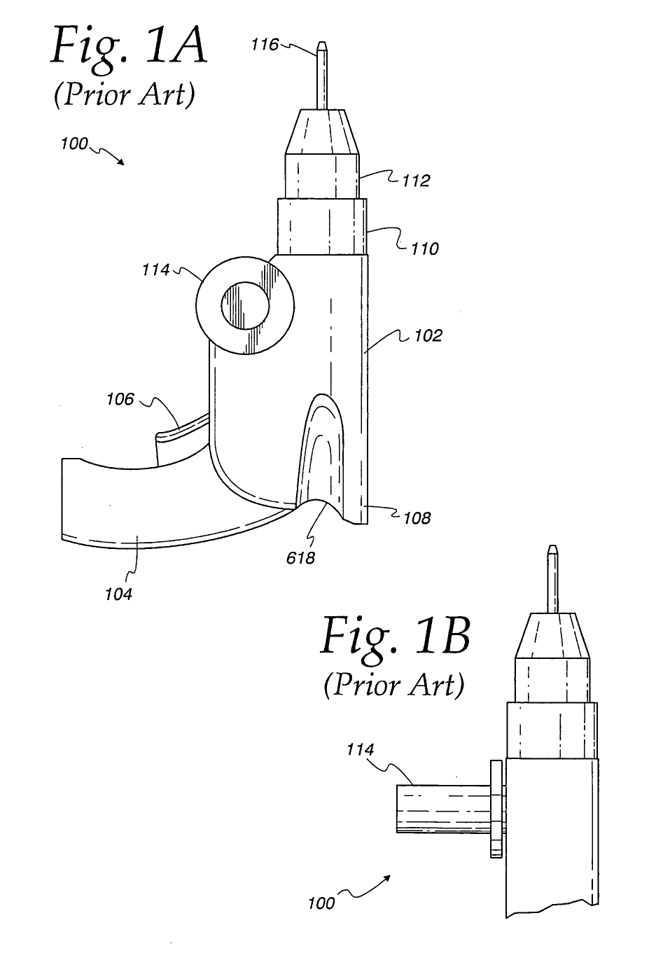

FIGS. 1A and 1B are elevational views of an example handheld power tool 100, which may be, for example, an example power drill 100. In particular, FIG. 1A is an elevational side view of the example power drill 100 and FIG. 1B is a partial elevational top view of the example power drill 100. The example apparatus and methods for holding and actuating power tools described herein are described with respect to a power drill such as, for example, the example power drill 100. However, it should be understood that the apparatus and methods described herein may be used in combination with other power tools.

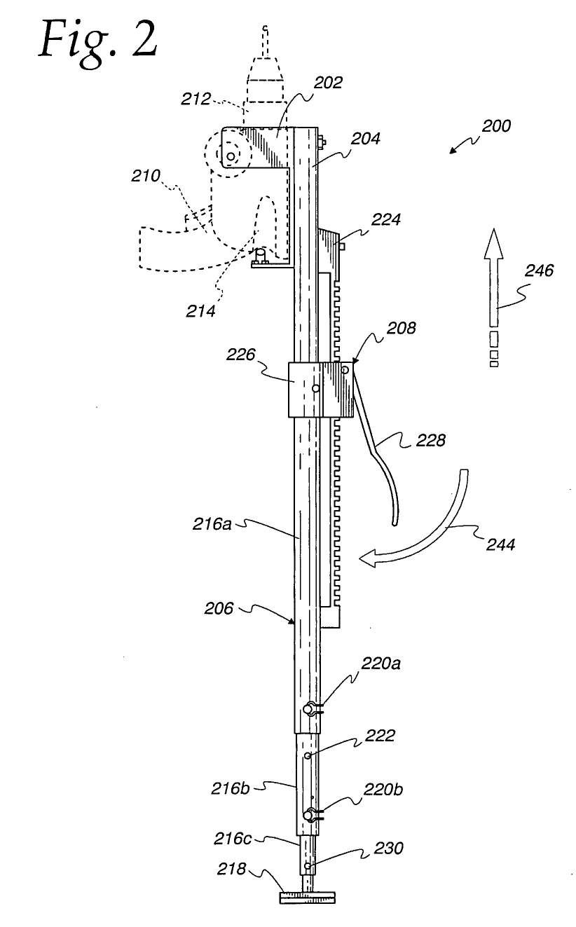

As described below in connection with FIGS. 2-15, the example apparatus and methods may be implemented using an inverted power tool press. The inverted power tool press will be described herein with respect to example inverted drill presses, which may be used to actuate, drive, or otherwise move a power tool (e.g., the example power drill 100) away from a base of the inverted drill press to engage (e.g., drill into, cut into, fasten onto, etc.) a work surface (e.g., a surface to be cut into, drilled into, or otherwise operated on) with a tool piece (e.g., a drill bit) held by the power tool. For purposes of clarity, the example power drill 100 will be described in greater detail prior to describing an inverted drill press.

Now turning in detail to FIG. 1, the example power drill 100 may be an electric drill or a pneumatic drill and may be used to cut into, drill into, fasten onto, and/or otherwise operate on a work surface (not shown). In one example application, the example power drill 100 may be used to drill or cut a hole into a work surface. In another example application, the example power drill 100 may be used to fasten a screw, bolt, nut, and/or any other fastener onto a work surface. As shown in FIG. 1, the example power drill 100 includes a chassis 102, a handle 104, a trigger 106, a butt end 108, a neck 110, a bit end 112 (i.e., a tool piece end), and a side handle 114.

The chassis 102 and the handle 104 are used to hold the electronic and mechanical parts used for operation of the example power drill 100. For example, the chassis 102 may be plastic, metal, or any other suitable material that may house components such as a motor, gears, wires, and other electrical and/or components. The handle 104 may include power electronics and a portion of a power cord for receiving electricity from an electrical source. Alternatively, the handle 104 may include a battery compartment for holding batteries that provide electrical power to the power drill 100. In addition, the handle 104 may be used by an operator to hold and operate the example power drill 100.

The trigger 106 may be used to turn the example power drill 100 on and off. In particular, the trigger 106 may be configured to operate a switch (not shown), which is internal to the chassis 102 or the handle 104, that engages and disengages power to a motor of the power drill 100.

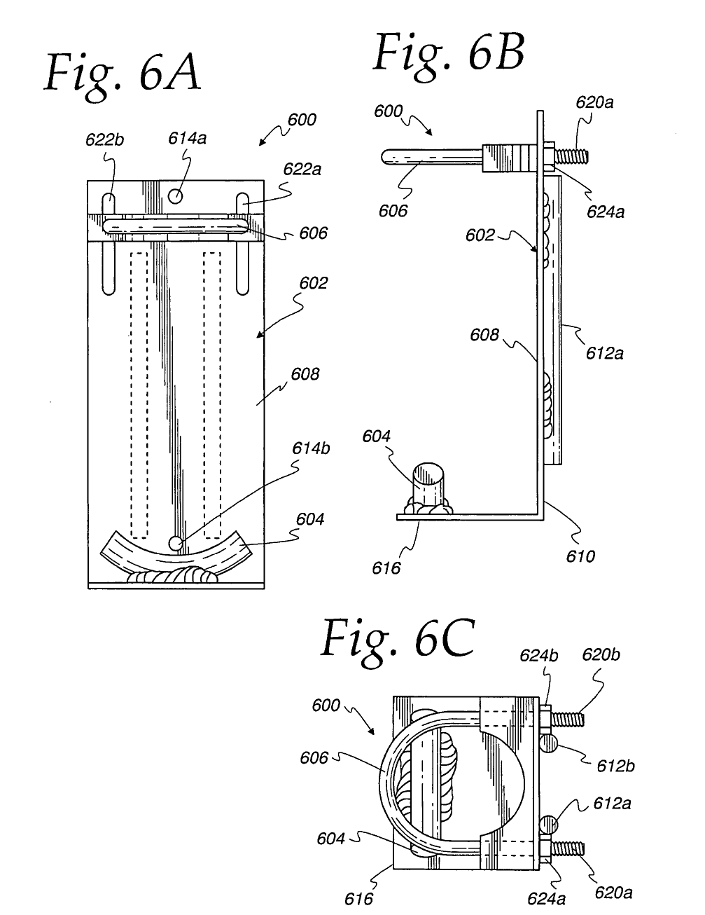

The butt end 108 may be integrally formed with the chassis 102 and the handle 104 and may be used for additional support of the example power drill 100 during operation. For example, in a two-handed drilling operation, an operator may hold the handle 104 with one hand and push or provide additional stability with the other hand by holding and/or applying pressure against the butt end 108. As described in detail in connection with FIGS. 6A-6C, 7A-7C, and 8A-8C, the butt end 108 is used for bracing or supporting the example power drill 100 when fastened to an inverted drill press.

The neck 110 is disposed between the chassis 102 and the bit end 112 and may be integrally formed with the chassis 102. The neck 110 provides a protective covering for a rotating shaft (not shown) that connects the motor of the example power drill 100 to the bit end 112. Typically, the neck 110 is stationary (i.e., does not rotate) with respect to the chassis 102. As described in detail in connection with FIGS. 6A-6C, 7A-7C, and 8A-8C, the neck 110 is used for bracing or supporting the example power drill 100 when fastened to an inverted drill press.

The bit end 112 is generally configured to hold a tool piece 116 such as, for example, a drill bit, a screw driver bit, a socket bit, etc. and is typically implemented using a chuck for holding the tool piece 116.

The side handle 114 shown in FIGS. 1A and 1B may be fastened to or mechanically coupled to a side of the example power drill 110. For example, the side handle 114 may be threaded into a threaded hole (not shown) in the chassis 102 using a bolt (not shown) or threaded end (not shown) of the side handle 114. As shown in FIG. 1B, the side handle 114 may protrude away from the example power drill 110. The side handle 114 may be used in, for example, two-handed drilling applications. In this manner, an operator can use one hand to hold the handle 104 and another hand to hold the side handle 114.

FIG. 2 is an elevational view of an example inverted drill press 200. The example inverted drill press 200 may be used to implement one or more of the example apparatus and methods for holding and actuating power tools described herein. In general, the example inverted drill press 200 may be used in combination with a power tool (e.g., the power drill 100 of FIG. 1) to operate on or engage a work surface with a tool piece held by the power tool. In particular, the tool piece engages a work surface that opposes or that is in a direction substantially opposite a support surface (e.g., a floor), which supports the inverted drill press 200. Many applications require power tools (e.g., power drills) to engage work surfaces that oppose or that are located in a direction that is substantially opposite a base or support point. In some cases, these applications involve drilling, cutting, fastening, etc. in a substantially upward direction. These jobs are typically performed by an operator (i.e., a person) that holds a power tool in an overhead or upright position. The apparatus and methods disclosed herein alleviate the amount of work required by an operator to perform work (e.g., drilling, cutting, fastening, etc.) on a surface in a substantially upward direction.

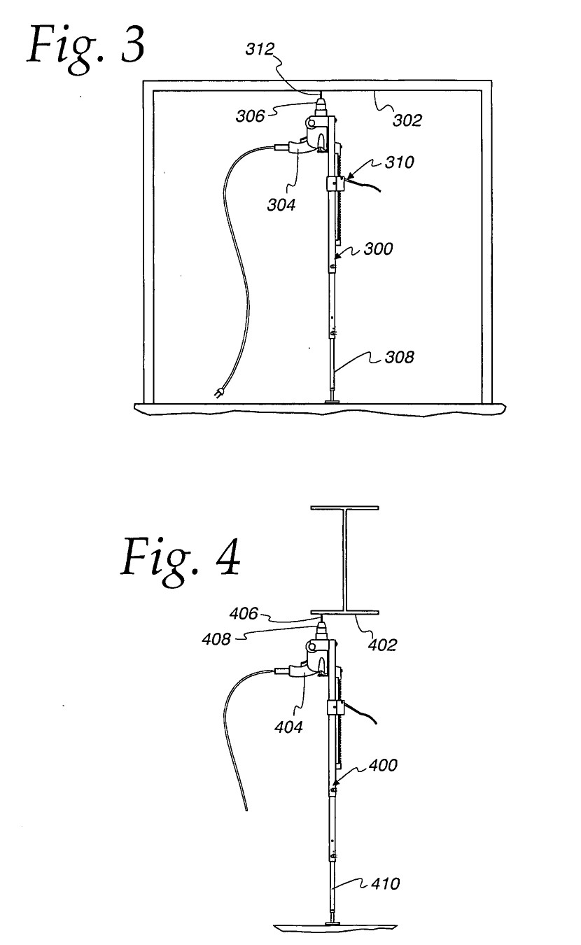

The example apparatus and methods described herein may be used to perform various jobs. In an example drilling application, a power drill that is holding a drill bit may be fastened onto an inverted drill press (e.g., the example inverted drill press 200) and used to drill holes into overhead work surfaces including overhead beams, door jams, ceilings, etc. More specifically, power tool operators working on a construction site often drill holes into overhead portions of door jams as described below in connection with FIG. 3. The number of times that the process is repeated depends on the number of door jams that are installed in a building. In an example fastening application, a power drill that is holding a screw driver bit or socket bit may be fastened onto an inverted drill press and used to fasten screws, bolts, nuts, etc. in an upward direction onto a work surface. These jobs are accomplished by holding a power drill in an overhead position for extended durations of time, which may cause a power tool operator to quickly fatigue, thus diminishing work output. Although the example apparatus and methods are described herein with respect to power drills, it would be apparent to one having ordinary skill in the art that the methods and apparatus can be adapted for use with other types of powered and non-powered tools for performing any type of work on a work surface. In addition, other applications of the example apparatus and methods disclosed herein will be readily apparent to one having ordinary skill in the art.

In general, the example inverted drill press 200 includes a tool fixture 202, a movable frame 204, a base 206, and an example actuator 208, all of which are coupled as shown. In addition, a power drill 210, shown by phantom lines, is coupled or fastened to the tool fixture 202. The power drill 210 is substantially similar or identical to the example power drill 100 of FIG. 1 and includes a bit end 212 and a butt end 214 and is supported in the inverted drill press 200 so that the bit end 212 points in a direction that is substantially opposite a location of the base 206. As the bit end 212 is driven toward and engages a work surface through actuation of the example actuator 208, the base 206 provides support by generating an equal and opposite force against a support surface (e.g., a floor). In this manner, a tool piece such as, for example, a drill bit can be driven into the work surface using a significant amount of force without taxing physical effort of an operator that would otherwise provide manual upward force while holding the drill.

Returning now to FIG. 2, the tool fixture 202 (i.e., a tool holder or a tool support) is configured to hold and/or support the power drill 210. However, the tool fixture 202 may be configured to support or be fastened to any powered or non-powered tool having any shape and size. As shown in FIG. 2, the tool fixture 202 is configured to hold the power drill 210 so that the bit end 212 is pointed and may move in a direction that opposes or is substantially opposite from a location of the base 206. The tool fixture 202 may be manufactured using any suitable design. For example, the tool fixture 202 may be manufactured to accept a power tool having a specific make and model. Alternatively, the tool fixture 202 may be manufactured as a generic design that may be adapted to fit various makes and models of power tools. Some example tool fixtures are described in greater detail below in connection with FIGS. 3, 4, and 5. In addition, the tool fixture 202 may be made of any suitable material or combination of materials such as, for example, plastic, metal, etc.

The movable frame 204 is mechanically coupled to the tool fixture 202 and slidably coupled to the base 206. The tool fixture 202 is held in a fixed position relative to the movable frame 204 so that as the movable frame 204 moves between a retracted position and an extended position relative to the base 206, the tool fixture 202 moves accordingly. In this manner, the movable frame 204 moves in a direction having coplanar alignment with the base 206 to drive the tool fixture 202 and the power drill 210 toward a work surface in a direction that opposes or is substantially opposite the location of the base 206. The movable frame 204 is shown in FIG. 2 as an elongated member, which may be implemented using a tube, a rod, or any other suitable element or combination of elements. In general, the movable frame 204 is assembled with the base 206 in a slidable, retractable, extendable, translatable, or otherwise movable manner to move the power drill 210 toward and away from a work surface.

As described above, the base 206 is slidably coupled to the movable frame 204. The base 206 functions as a substantially stationary support for the inverted drill press 100 and, according to one example, is implemented using a first elongated member 216a, a second elongated member 216b, a third elongated member 216c, and a base pad or support pad 218. The support pad 218 is configured to engage a support surface (e.g., a floor) so that as a tool piece (e.g., a drill bit, a screw driver bit, a socket bit, etc.) held by the power drill 210 engages a work surface with a driving force, the elongated members 216a-c generate an opposing force against the support pad 218, thus causing the support pad 218 to push against the support surface. In this manner, the power drill 210 may be driven toward a work surface with a significant amount of force.

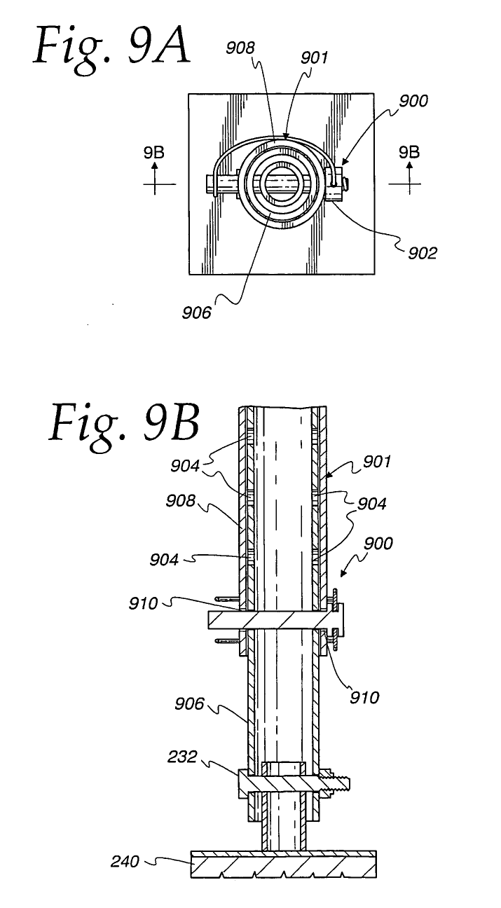

Each of the elongated members 216a-c may be implemented using a tube, a rod, or any other suitable element or combination of elements including elements having a non-circular cross-section. As shown in FIG. 2, the elongated members or tubes 216a-c are arranged in a telescoping configuration, which enables adjusting the length or height of the example inverted drill press 200 from at least a first length or height to a second length or height. In particular, the height of the example inverted drill press 200 may be adjusted by locking the tubes 216a-c at various heights using height adjustment apparatus. The number of heights to which the example inverted drill press 200 is adjustable is configurable to any desired number of heights. The example height adjustment apparatus shown in FIG. 2 includes a clevis pins 220a and 220b in combination with an array of pin apertures, which are partially represented by a pin aperture 222. Other example height adjustment apparatus are described in greater detail below in connection with FIGS. 9A, 9B, 10A, 10B, 11A, and 11B. Although, the base 206 includes the elongated members 216a-c, the base 206 may be implemented using one or more elongated members. In an alternative configuration, the base 206 may be implemented using three tubes arranged in a tripod configuration. Alternatively, the base 206 may be implemented using any other structural configurations.

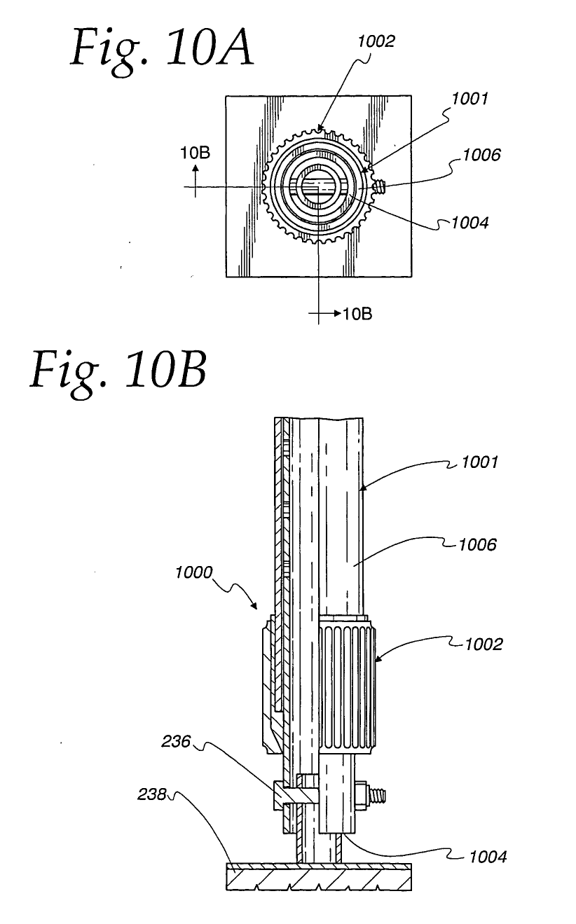

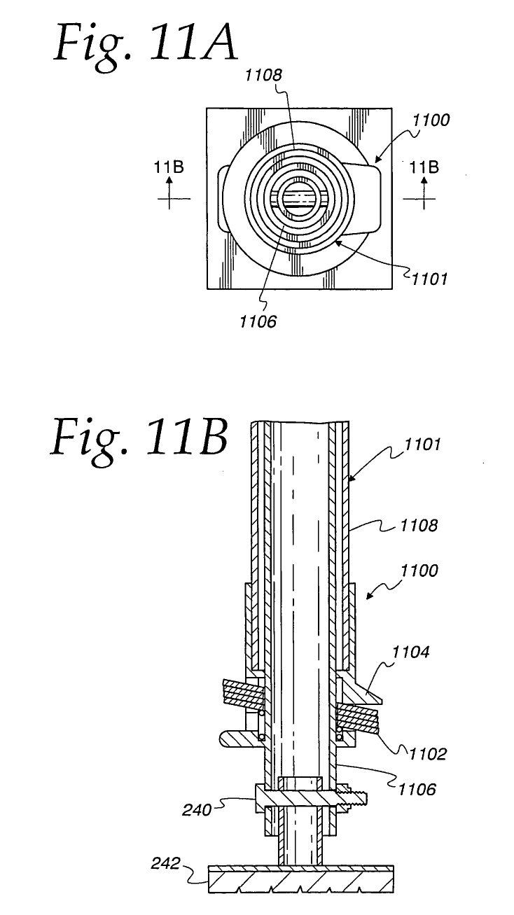

The base 206 may be configured to pivot on the support pad 218 to allow operation of, for example, the example power drill 100 (FIG. 1) at any desired angle. More specifically, the tube 216c may be pivotally coupled to the support pad 218 using a pin 230. Referring briefly to FIGS. 9B, 10B, and 11B, pins that are substantially similar or identical to pin 230 and which are used to pivotally couple a base to a support pad are shown in greater detail. In FIG. 9B, a pin 232 pivotally couples a base 901 to a support pad 234. Similarly, in FIGS. 10B and 11B, respective pins 236 and 240 pivotally couple respective bases 1001 and 1101 to respective support pads 238 and 242.

Returning now to FIG. 2, the example actuator 208 is coupled to the movable frame 204 and the base 206 and is implemented using a rack and pinion configuration. As shown in FIG. 2, the example actuator 208 includes a movable element 224, a fixed element 226, and an actuating element 228. The movable element 224 is mechanically coupled in a fixed position to the movable frame 204 and movably engages the fixed element 226 and the actuating element 228. The fixed element 226 is mechanically coupled in a fixed position to the base 206. The actuating element 228 is pivotally coupled to the fixed element 224. In general, the example actuator 208 is configured to actuate or translate the movable frame 204 between a retracted position and an extended position relative to the base 206. In this manner, the power drill 210 can be moved to and from a work surface. For example, during operation, an operator actuates the actuating element 228 in a direction generally indicated by arrow 244, which causes the actuating element 228 to engage and move the movable element 224 in a direction generally indicated by arrow 246. The movable element 224 then causes the movable frame 204 to translate in a direction generally indicated by the arrow 246. The arrow 246 points in a direction that is substantially away from the base 206 or support surface (e.g., a floor) and substantially toward a work surface (not shown). The actuating element 228 may be configured to provide substantial leverage for generating a significant amount of force for driving a tool piece held by the power drill 210 toward and/or into a work surface while minimizing operator-required force.

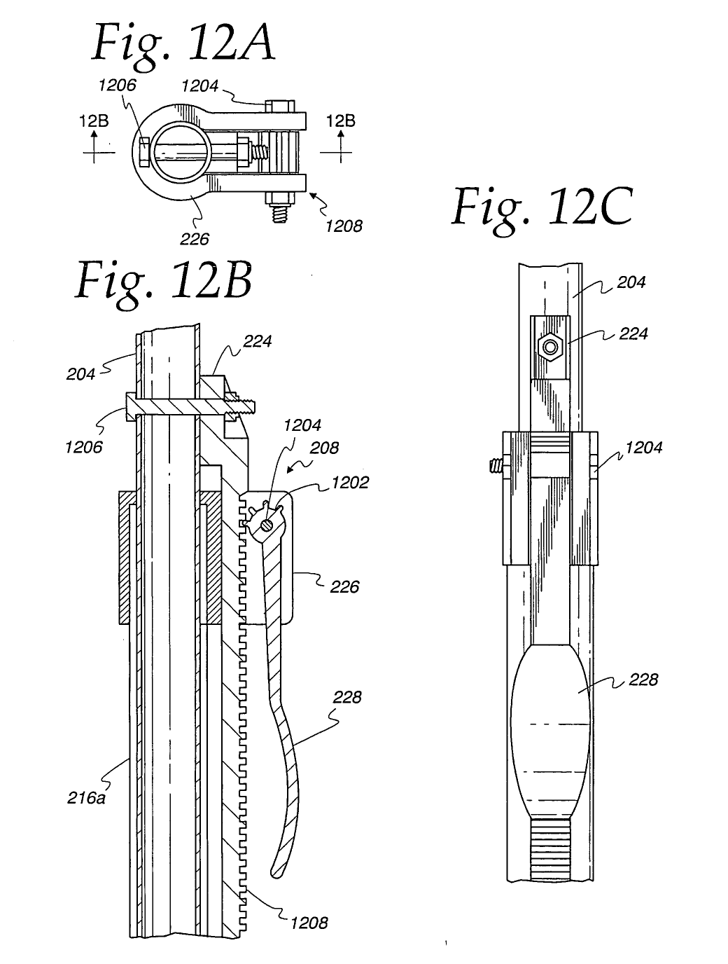

The structure and operation of the example actuator 208 is described in greater detail below in connection with FIG. 12. Although the example actuator 208 is implemented using a rack and pinion configuration, one having ordinary skill in the art will readily appreciate that the example actuator 208 may be implemented using any other configuration suitable for moving the movable frame 206 between a retracted and extended position. For example, an alternate implementation of an actuator is described below in connection with FIG. 11.

FIGS. 3, 4, and 5 are elevational views of example inverted drill presses 300, 400, and 500 used in various example applications and which may be implemented using the example inverted drill press 200 of FIG. 2. More specifically, the example inverted drill presses 300, 400, and 500 are used in applications in which a power drill is held or supported so that a bit end of the power drill points in a direction that generally opposes or is substantially opposite the location of a support surface (e.g., a floor). As described above in connection with FIG. 2, an actuator is used to drive or move a bit end (e.g., the bit end 112 of FIG. 1) of a power drill (e.g., the example power drill 100 of FIG. 1) toward a work surface. In this manner, when used in a drilling application to engage a work surface with a tool piece (e.g., a drill bit), the example inverted drill presses 300, 400, and 500 may be used to maintain an engaging force in a direction that generally opposes or is substantially opposite from a location of a base (e.g., the base 218 of FIG. 2) or support surface until a desired depth is reached.

Although the example inverted drill presses 300, 400, and 500 are shown holding a drill in a substantially upward direction, the example inverted drill presses 300, 400, and 500 may be used to move or drive the drill toward a work surface in any direction and at any angle that generally opposes or is substantially opposite from a location of the bases of the example inverted drill presses 300, 400, and 500.

As shown in FIG. 3, an example application involves using the example inverted drill press 300 to drill an overhead hole into a door jam 302, which is one example work surface. A power drill 304 is fastened onto the example inverted drill press 300 so that a bit end 306 of the power drill 304 points in a direction that generally opposes or is substantially opposite a base 308 of the example inverted drill press 300. The example inverted drill press 300 includes an actuator 310 that is configured to drive the power drill 304 substantially away from or in a generally opposing direction relative to the base 308 as described above in connection with FIG. 2, thus causing a drill bit 312 that is held by the bit end 306 to engage the door jam 302 (i.e., a work surface).

In another example application shown in FIG. 4, the example inverted drill press 400 is used to drill an overhead hole in an I-beam 402 (i.e., a work surface). As shown in FIG. 4, a power drill 404 is held so that a drill bit 406, which is held by a bit end 408, engages the I-beam 402 as the power drill 404 is moved in a direction that generally opposes or is substantially opposite a base 410 of the example inverted drill press 400.

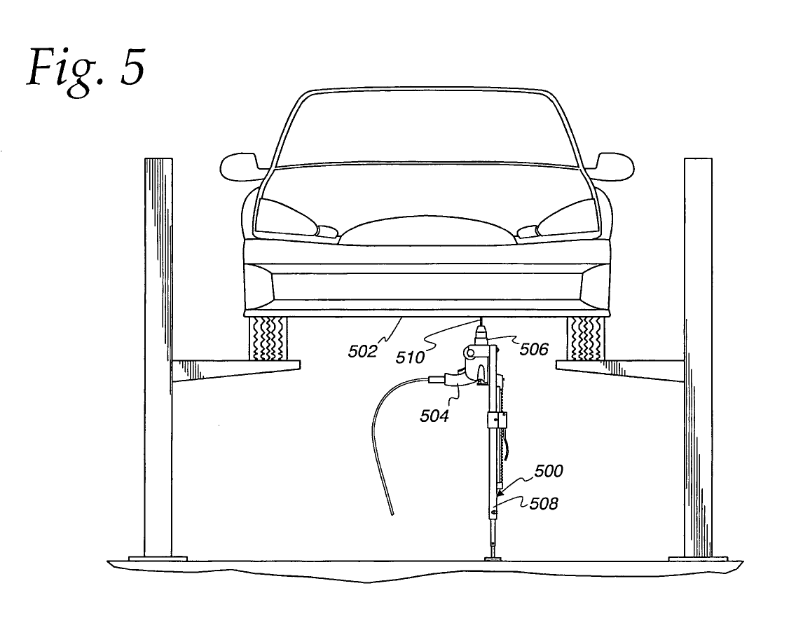

In yet another example application shown in FIG. 5, the example inverted drill press 500 is used to perform automotive work to fasten a bolt in a substantially upward direction onto an automotive undercarriage 502 (i.e., a work surface). The example inverted drill press 500 is fastened to a power drill 504 and functions in a substantially similar manner as the example inverted drill presses 300 and 400 of FIGS. 3 and 4 to drive a bit end 506 of the power drill 504 in a direction substantially away from a base 508. In particular, a socket bit 510 is held by the bit end 506 and driven away from or in a generally opposing direction relative to the base 508 to engage and fasten, for example, a bolt (not shown) onto the automotive undercarriage 502.

Although the example inverted drill press 500 is used in an application potentially requiring a shorter height than the applications illustrated in FIGS. 3 and 4, the example inverted drill press 500 may be implemented by any of the example inverted drill presses 200, 300, and 400 of FIGS. 2, 3, and 4. More specifically, the height of each of the example inverted drill presses 200, 300, 400, and 500 may be adapted to accommodate various heights in a substantially similar or identical manner as described above in connection with FIG. 2 using a height adjustment apparatus such as, for example, the example height adjusting apparatus described below in connection with FIGS. 9A, 9B, 10A, 10B, 11A, and 11B. In particular, the height adjustment apparatus may be used to set the heights of the example inverted drill presses 200, 300, 400, and 500 so that their respective power drills (i.e., the power drills 210, 304, 404, and 504) are positioned in proximity to a work surface. During operation of the power drills 210, 304, 404, and 504, an actuator such as, for example, one of the example actuators 208 (FIG. 2) and 310 (FIG. 3) may then be used to drive the power drills 210, 304, 404, and 504 toward the work surface.

FIGS. 6A, 6B, and 6C illustrate various views of an example tool fixture 600 that may be used with any of the example inverted drill presses 200, 300, 400, and 500 of FIGS. 2 through 5. In particular, FIG. 6A is an elevational front view of the example tool fixture 600, FIG. 6B is an elevational side view of the example tool fixture 600, and FIG. 6C is a plan view of the example tool fixture 600. The example tool fixture 600 may be used to implement the tool fixture 202 of FIG. 2 and may be configured to hold a power tool such as, for example, the example power drill 100 of FIG. 1. More specifically, the tool fixture 600 may be mechanically coupled to a movable frame of an inverted drill press (e.g., the movable frame 204 of the example inverted drill press 200 of FIG. 2) and may be configured to hold the example power drill 100 so that the bit end 112 is pointed in a direction that generally opposes or is substantially opposite a base (e.g., the base 206 described above in connection with FIG. 2) of the inverted drill press. The tool fixture 600 may be manufactured using any material such as, for example, metal, plastic, composite materials, etc.

As shown in FIGS. 6A, 6B, and 6C, the tool fixture 600 includes a fixture frame 602, a saddle 604, and a neck bracket 606 (i.e., a tool fastener), all of which are coupled as shown. The fixture frame 602 includes a front frame portion 608 (FIGS. 6A and 6B) and a back frame portion 610 (FIG. 6B). The front frame portion 608 is configured to receive a chassis of a power tool such as for example the chassis 102 (FIG. 1) of the example power drill 100 (FIG. 1). The back frame portion 610 is configured to engage a surface of a movable frame (e.g., the movable frame 204 of FIG. 2) when the fixture frame 602 is mechanically coupled to the movable frame.

As shown in FIGS. 6B and 6C, a first lateral brace 612a and a second lateral brace 612b are mechanically coupled to the back frame portion 610. The lateral braces 612a-b provide lateral stability for the fixture frame 602 by substantially immobilizing the fixture frame 602 in a lateral direction when mechanically coupled to a curved surface. For example, the fixture frame 602 may be mechanically coupled to a tube (e.g., the movable frame 204). Without the lateral braces 612a-b, the curved surface of the tube may cause the fixture frame 602 to tilt from side to side during operation.

The fixture frame 602 may be mechanically coupled to the movable frame 204 (FIG. 2) in any suitable manner. For example, the fixture frame 602 includes a first fastening hole 614a and a second fastening hole 614b that may be used to mechanically couple the fixture frame 602 to the movable frame 204 using screws. Alternatively, the fixture frame 602 may be welded onto the movable frame 204 by, for example, forming a weld joint between the lateral braces 612a-b and a surface of the movable frame 204.

As shown in FIGS. 6B and 6C, the fixture frame 602 also includes a platform 616 that is configured to receive and support a butt end of a power tool (e.g., the butt end 108 of the example power drill 100 of FIG. 1) by providing support for the saddle. The platform 616 may be substantially planar as shown in FIG. 6B or it may be contoured to form-fit, for example, the butt end 108 of the example power drill 100.

The saddle 604 shown in FIGS. 6A, 6B, and 6C is configured to restrain a power tool (e.g., the example power drill 100 of FIG. 1) from sliding or falling off of the platform 616. For example, the butt end 108 (FIG. 1) of the example power drill 100 may be placed on the platform 616 so that a concave surface 618 shown in FIG. 1 of the butt end 108 straddles the saddle 604. In this manner, the example power drill 100 may be locked in place or immobilized to prevent disengagement from the example tool fixture 600 during operation. The saddle 604 may be integrally formed with the platform 616. Alternatively, the saddle 604 may be mechanically coupled to the platform 616. For example, the saddle 604 may be welded to the platform 616 as shown in FIGS. 6A, 6B, and 6C.

The neck bracket 606 or tool fastener is configured to fasten or secure a power tool (e.g., the example power drill 100) to the example tool fixture 600. More specifically, the neck bracket 606 may fasten the example power drill 100 around the neck 110 (FIG. 1). As shown in FIGS. 6B and 6C, the neck bracket 606 is implemented using a U-bolt that includes a first threaded end 620a and a second threaded end 620b. The threaded ends 620a-b are fed through two slotted holes 622a and 622b (FIG. 6A) of the fixture frame 602. In addition, as shown in FIGS. 6B and 6C, a first nut 624a is fastened to the first threaded end 620a and a second nut 624b is fastened to the second threaded end 620b. Tightening the nuts 624a-b on the threaded ends 620a-b cause the neck bracket 606 to draw the neck 110 toward the fixture frame 602, thus fastening or securing the example power drill 100 onto the example tool fixture 600.

The slotted holes 622a-b enable the neck bracket 606 to move toward and away from the platform 616. In this manner, the neck bracket 606 may be adjusted to accommodate power tools having various sizes.

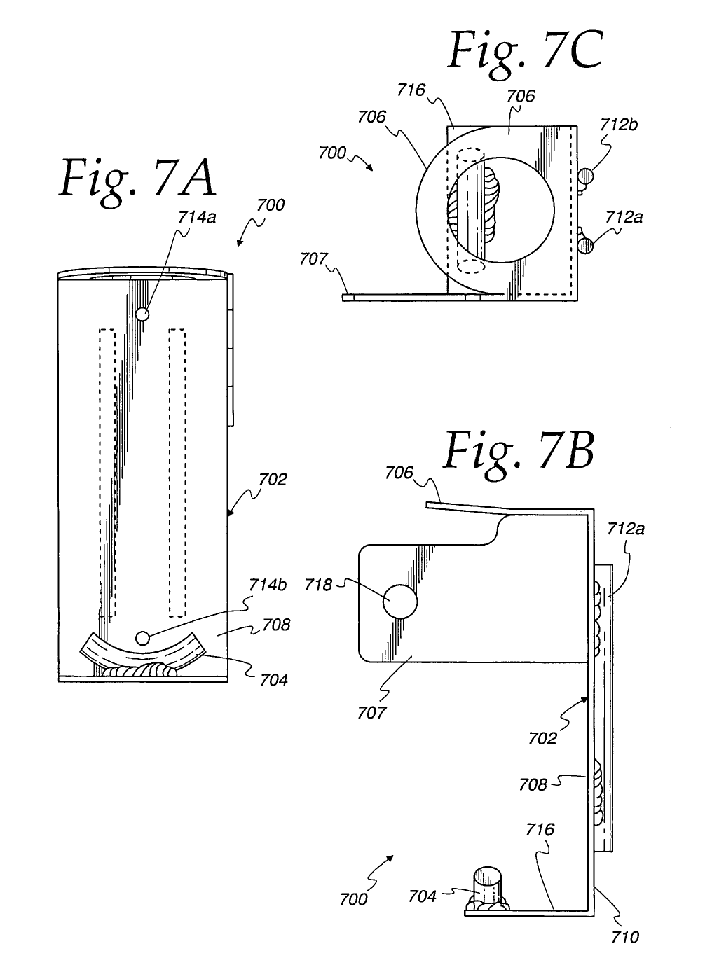

FIGS. 7A, 7B, and 7C illustrate various views of another example tool fixture 700 that may be used with any of the example inverted drill presses 200, 300, 400, and 500 of FIGS. 2 through 5. In particular, FIG. 7A is an elevational front view of the example tool fixture 700, FIG. 7B is an elevational side view of the example tool fixture 700, and FIG. 7C is a plan view of the example tool fixture 700. The example tool fixture 700 may be used to implement the tool fixture 202 of FIG. 2 and may be configured to hold a power tool such as, for example, the example power drill 100 of FIG. 1. More specifically, the example tool fixture 700 may be mechanically coupled to a movable frame of an inverted drill press (e.g., the movable frame 204 of the example inverted drill press 200 of FIG. 2) and may be configured to hold the example power drill 100 so that the bit end 112 is pointed in a direction that opposes or is substantially opposite a base (e.g., the base 206 described above in connection with FIG. 2) of the inverted drill press. The example tool fixture 700 may be manufactured using any material such as, for example, metal, plastic, composite materials, etc.

The example tool fixture 700 includes a fixture frame 702, a saddle 704, a neck bracket 706, and a side handle bracket 707, all of which are coupled as shown. The fixture frame 702 is substantially similar to the fixture frame 602 of FIG. 6. For example, the fixture frame 702 includes a front frame portion 708 (FIGS. 7A and 7B) and a back frame portion 710 (FIG. 7B). In addition, two lateral braces 712a and 712b (FIGS. 7B and 7C), which are substantially similar or identical to the lateral braces 612a-b of FIGS. 6B and 6C are mechanically coupled to the back frame portion 710. The fixture frame 702 also includes two fastening holes 714a and 714b (FIG. 7A) and a platform 716 (FIGS. 7B and 7C). The fastening holes 714a-b are substantially similar or identical to the fastening holes 614a-b of FIG. 6A and the platform 716 is substantially similar or identical to the platform 616 of FIG. 6. The saddle 704 (FIGS. 7A, 7B, and 7C), which is substantially similar or identical to the saddle 604 of FIGS. 6A, 6C, and 6B, may be mechanically coupled to or integral with the platform 716.

The neck bracket 706 shown in FIGS. 7B and 7C may be integral with the fixture frame 702. Alternatively, the neck bracket 706 may be mechanically coupled (e.g., welded) to the fixture frame 702. The function of the neck bracket 706 is substantially similar to the function of the neck bracket 606 (FIGS. 6A, 6B, and 6C). However, the neck bracket 706 is configured to remain in a fixed position. In this manner, the example tool fixture 700 may be configured to receive power tools (e.g., power drills) of substantially similar size. The example tool fixture 700 may be manufactured for an inverted drill press that is paired with a specific power drill or with a specific line of power drills from a particular manufacturer. In this manner, a power drill manufacturer can build brand loyalty among customers.

The side handle bracket 707 shown in FIGS. 7B and 7C may be used as a tool fastener and configured to fasten or secure, for example, the example power drill 100 of FIG. 1 to the example tool fixture 700 using the side handle 114 (FIG. 1). More specifically, the side handle 114 may be removed (e.g., unscrewed, unfastened, etc.) from the example power drill 100 prior to placing the power drill 100 into the tool fixture 700. After placing the power drill 100 into the tool fixture 700, a threaded side handle hole (not shown) in the chassis 102 (FIG. 1) of the power drill 100 may be aligned with a fastening hole 718 of the side handle bracket 707. The side handle 114 may then be inserted through the fastening hole 718 and fastened or screwed into the threaded side handle hole of the chassis 102. In this manner, the side handle bracket 707 is captured between the side handle 114 and the chassis 102 to fasten or secure the power drill 100 to the tool fixture 700. The side handle bracket 707 may be integral with the fixture frame 702. Alternatively, the side handle bracket 707 may be mechanically coupled (e.g., welded) to the fixture frame 702.

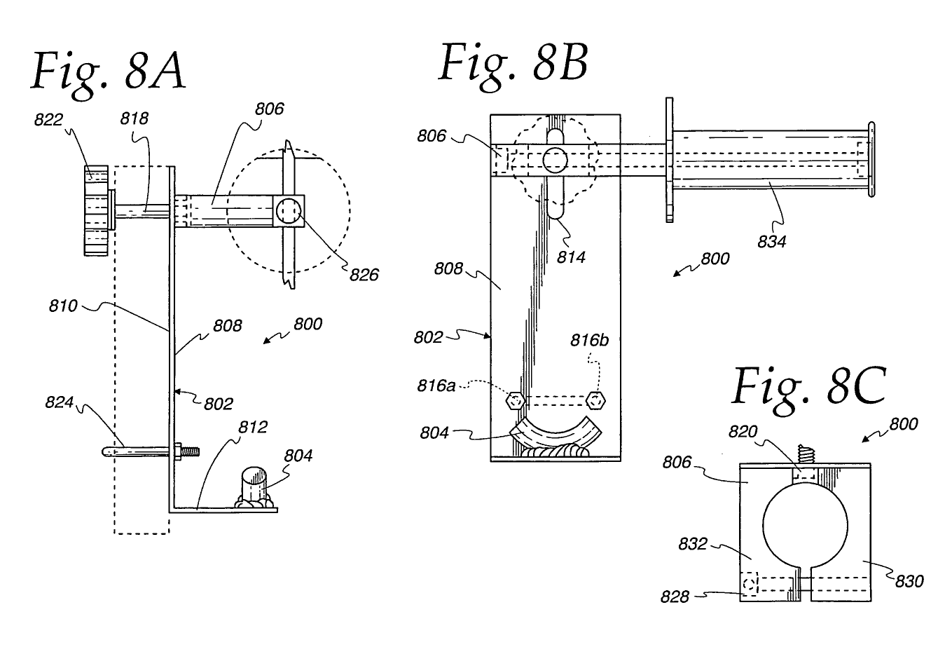

FIGS. 8A, 8B, and 8C illustrate various views of another example tool fixture 800 that may be used with any of the example inverted drill presses 200, 300, 400, and 500 of FIGS. 2 through 5. In particular, FIG. 8A is an elevational side view of the example tool fixture 800, FIG. 8B is an elevational front view of the example tool fixture 800, and FIG. 8C is a plan view of the example tool fixture 800. The example tool fixture 800 may be used to implement the tool fixture 202 of FIG. 2 and may be configured to hold a power tool such as, for example, the example power drill 100 of FIG. 1. More specifically, the tool fixture 800 may be mechanically coupled to a movable frame of an inverted drill press (e.g., the movable frame 204 of the inverted drill press 200 of FIG. 2) and may be configured to hold the power drill 100 so that the bit end 112 is pointed in a direction that opposes or is substantially opposite a base (e.g., the base 206 described above in connection with FIG. 2) of the inverted drill press. The tool fixture 800 may be manufactured using any material such as, for example, metal, plastic, composite materials, etc.

The tool fixture 800 includes a fixture frame 802, a saddle 804, and a neck bracket 806 (i.e., a tool fastener), all of which are coupled as shown. The fixture frame 802, as shown in FIGS. 8A and 8B, is substantially similar to the fixture frames 602 (FIGS. 6A and 6B) and 702 (FIGS. 7A and 7B). For example, the fixture frame 802 includes a front frame portion 808 (FIGS. 8A and 8B) and a back frame portion 810 (FIG. 8A). In addition, the fixture frame 802 includes a platform 812 (FIG. 8A), which is substantially similar to the platforms 616 (FIGS. 6B and 6C) and 716 (FIGS. 7B and 7C). The fixture frame 802 also includes a slotted mounting hole 814 (FIG. 8B) and two bracket holes 816a and 816b (FIG. 8B) for securing or fastening the example tool fixture 800 to, for example, the movable frame 204 (FIG. 2) of the example inverted drill press 200.

The slotted mounting hole 814 may be configured to accept a mounting screw 818 shown in FIG. 8A. For example, a hole (not shown) may be drilled through the center of the movable frame 204 (FIG. 2) substantially perpendicular to the axis of the movable frame 204. The mounting screw 818 may be inserted through the hole of the movable frame 204 and the slotted mounting hole 814 and may be threaded into a threaded hole 820 (FIG. 8C) of the neck bracket 806. As the mounting screw 818 is threaded into the threaded hole 820 the tool fixture 800 is fastened to the movable frame 204 by capturing the movable frame 204 between a head 822 of the mounting screw 818 and the back frame portion 810. The shape of the slotted mounting hole 814 enables sliding the fixture frame 802 toward and away from the base 206 (FIG. 2) of the example inverted drill press 200. In this manner, the tool fixture 800 may be used to hold power tools (e.g., power drills) having various sizes.

The bracket holes 816a-b may be configured to receive a U-bracket 824 (FIG. 8A) that is configured to fasten the bottom of the fixture frame 802 to, for example, the movable frame 204 (FIG. 2).

The saddle 804 (FIGS. 8A and 8B) is substantially similar or identical to the saddles 606 (FIGS. 6A, 6B, and 6C) and 706 (FIGS. 7A, 7B, and 7C). The saddle may be mechanically coupled (e.g., welded) to and/or integral with the platform 812.

The neck bracket 806 or tool fastener (FIGS. 8A and 8C) is implemented by a clamping bracket that constricts around, squeezes, or otherwise clamps onto, for example, the neck 110 (FIG. 1) of the example power drill 100 (FIG. 1). The neck bracket 806 includes the threaded hole 820 (FIG. 8C) and a side handle hole 826 shown in FIG. 8A. As described above, the threaded hole 820 is used to fasten the example tool fixture 800 to, for example, the movable frame 204 (FIG. 2). The side handle hole 826 includes a threaded portion and a non-threaded portion. The threaded portion is located at a bracket corner 828 (FIG. 8C) and is used to draw a first bracket side 830 (FIG. 8C) and a second bracket side 832 (FIG. 8C) of the neck bracket 806 toward one another. More specifically, a threaded rod (not shown) of a side handle 834 (FIG. 8B) is inserted into the side handle hole 826 through the first bracket side 830 and is fed toward the second bracket side 832. As the threaded rod of the side handle 834 engages the threaded portion (located at the bracket corner 828) of the side handle hole 826, the side handle 834 may be screwed, threaded, and/or otherwise fastened into the threaded portion, which causes the bracket sides 830 and 832 to be drawn together. In this manner, the neck bracket 806 constricts around, squeezes, or otherwise clamps the neck 110, thus fastening the example power drill 100 to the example tool fixture 800.

FIG. 9A illustrates a plan view and FIG. 9B illustrates a cross-sectional view of an example height adjustment apparatus 900 that may be used with any of the example inverted drill presses 200, 300, 400, and 500 of FIGS. 2 through 5. In particular, FIG. 9A is a plan view of an example base 901 which includes the example height adjustment apparatus 900 and FIG. 9B is a cross-sectional side view of the example base 901 and the example height adjustment apparatus 900. The height adjustment apparatus includes a clevis pin 902 (FIG. 9A) and a plurality of height adjustment holes 904 (FIG. 9B). In addition, the example base 901 may implement the base 206 of FIG. 2.

As shown in FIG. 9B, the height adjustment apparatus 900 is implemented in combination with a first elongated member 906 (e.g., a tube) and a second elongated member 908 (e.g., a tube) that are assembled in a telescoping arrangement. The height adjustment holes 904 are formed through the center of the first tube 906. In addition, a set of outer holes 910 are formed through the center of the second tube 908 to receive the clevis pin 902.

The set of outer holes 910 may be aligned to a set of height adjustment holes 904 to set a desired height of, for example, the example inverted drill press 200 (FIG. 2). After the set of outer holes 910 is aligned with a set of the height adjustment holes 904, the clevis pin 902 is inserted through the aligned holes, thus passing through the center of the tubes 906 and 908 as shown in FIG. 9A.

As shown in FIG. 9B, the clevis pin 902 includes a safety element 912 that may be implemented by a cotter pin, which is well known in the art. The safety element 912 may be used to secure the clevis pin 902 during operation of, for example, the example inverted drill press 200 (FIG. 2). The safety element 912 is inserted through the center of the clevis pin 902 and prevents the clevis pin 902 from being knocked out or falling out of the holes 904 and 910. Alternatively, the safety element 912 may be a clamp that clamps onto the outer surface of the clevis pin 902.

FIG. 10A illustrates a plan view and FIG. 10B illustrates a cross-sectional view of another example height adjustment apparatus 1000 that may be used with any of the example inverted drill presses 200, 300, 400, and 500 of FIGS. 2 through 5. In particular, FIG. 10A is a plan view of an example base 1001 that includes the example height adjustment apparatus 1000 and FIG. 10B is a cross-sectional side view of the example base 1001 and the example height adjustment apparatus 1000. The example base 1001 may implement the base 206 of FIG. 2. The example height adjustment apparatus 1000 includes a twist-lock mechanism 1002 (FIGS. 10A and 10B). The twist-lock mechanism 1002 is well-known in the art and is often used to lock telescoping tubes in a desired position, thus fixing the position of the telescoping tubes relative to one another.

As shown in FIGS. 10A and 10B, the example height adjustment apparatus 1000 is implemented in combination with a first elongated member 1004 (e.g., a tube) and a second elongated member 1006 (e.g., a tube) that are assembled in a telescoping arrangement. More specifically, the first tube 1004 is configured to slide within the second tube 1006 to adjust the height of, for example, the example inverted drill press 200 of FIG. 2. After sliding the first tube 1004 in or out of the second tube 1006 to set a desired height, the twist-lock mechanism 1002 may be actuated or twisted to lock the first tube 1004 and the second tube 1006 in a fixed position relative to one another.

FIG. 11A illustrates a plan view and FIG. 11B illustrates a cross-sectional view of another example height adjustment apparatus 1100 that may be used with any of the example inverted drill presses 200, 300, 400, and 500 of FIGS. 2 through 5. In particular, FIG. 11A is a plan view of an example base 1101 that includes the example height adjustment apparatus 1100 and FIG. 11B is cross-sectional side view of the example base 1101 and the example height adjustment apparatus 1100. The example base 1101 may implement the base 206 of FIG. 2. The example height adjustment apparatus includes one or more slip-disc grip fasteners 1102 (FIG. 11B) and a slip-disc actuator 1104. The slip-disc grip fasteners 1102 are well-known in the art and are used in various applications such as, for example, in bar clamps for opening and closing clamps.

As shown in FIG. 11B, the example height adjustment apparatus 1100 includes a first elongated member 1106 (e.g. a tube) and a second elongated member 1108 (e.g., a tube) assembled in a telescoping arrangement. In particular, the first tube 1106 may be slid within the second tube 1108 to adjust the height of, for example, the example inverted drill press 200 of FIG. 2.

The slip-disc actuator 1104 is configured to lock and release the slip-disc grip fasteners 1102. The slip-disc actuator 1104 may be configured with a spring-like action to default to a locking position so that the tubes 1106 and 1108 remain in a fixed position relative to one another. Changing the height of the example inverted drill press 200 (FIG. 2) involves first actuating the slip-disc actuator 1104 to release the slip-disc grip fasteners 1102 from a locking position so that the first tube 1106 may be retracted into or extracted from the second tube 1108. After the tubes 1106 and 1108 are positioned to a desired height, the slip-disc actuator 1104 may be released, which causes the slip-disc actuator 1104 to return to the defaulted locking position, thus causing the slip-disc grip fasteners 1102 to grasp or clamp onto the first tube 1106 and fix the position of the first tube 1106 relative to the second tube 1108.

FIGS. 12A, 12B, and 12C illustrate various views of the example actuator 208 of the example inverted drill press 200 of FIG. 2. In particular, FIG. 12A illustrates a plan view of the example actuator 208, FIG. 12B illustrates a cross-sectional side view of the example actuator 208, and FIG. 12C illustrates another side view of the example actuator 208. The example actuator 208 is based on a rack and pinion assembly that may be used to move an inverted drill press between an extended position and a retracted position, thus moving a power tool (e.g., the example power drill 100 of FIG. 1) toward and away from a work surface. The example actuator 208 may be used with any of the example inverted drill presses 200, 300, 400, and 500 of FIGS. 2 through 5. As shown in FIGS. 12A, 12B, and 12C, the example actuator 208 includes the fixed element 226 (i.e., an actuator bracket) pivotally coupled to the actuating element 228 (i.e., an actuator handle), which includes a pinion 1202 that is coupled to the movable element 224 (i.e., a rack).

As shown in FIGS. 12A and 12B, the actuator bracket 226 is mechanically coupled in a fixed position to the first elongated member or tube 216a (e.g., a tube) and is pivotally coupled to the actuator handle 228 via a screw 1204. The screw 1204 functions as a fulcrum for the actuator handle 228.

As shown in FIGS. 12B and 12C, the rack 224 is mechanically coupled to the movable frame 204 via a screw 1206 and extends through the actuator bracket 226. The rack 224 remains in a fixed position relative to the movable frame 204 and moves relative to and along the length of the first tube 216a. The rack 224 includes a plurality of teeth 1208 that are engaged by the pinion 1202. As the actuator handle 228 is actuated (e.g., swung out or swung in), the pinion 1202 actuates the rack 224, which causes the movable frame 204 to move between an extended position and a retracted position.

In an alternative implementation, the handle may be configured to travel through a 360° rotation so that the extension of the movable frame 204 is only limited by the length of the rack 224. For example, with respect to FIG. 12C, an alternative actuator handle may be configured to extend to the left or to the right of the actuator bracket 226 to prevent any interference between the alternative actuator handle and the first tube 216a or the movable frame 204. In addition, the alternative actuator handle may include a pinion that is configured with teeth in a 360° formation for continuous engagement with the teeth 1204 of the rack 224 as the handle rotates about a 360° rotation.

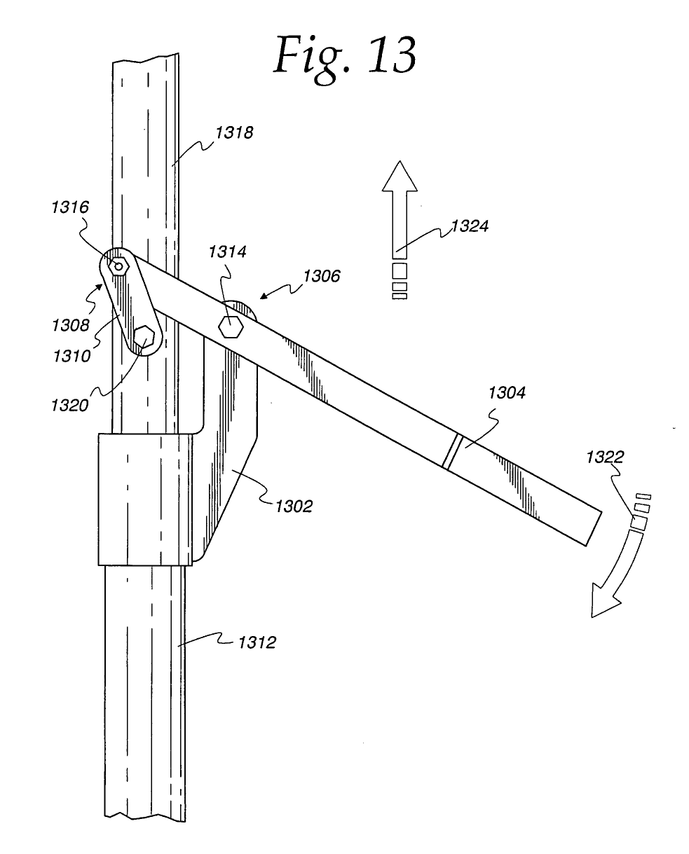

FIG. 13 illustrates an elevational view of another example actuator 1300 that may be used with any of the example inverted drill presses 200, 300, 400, and 500 of FIGS. 2 through 5. The example actuator 1300 is based on a multiple hinge system that may be used to move an inverted drill press between an extended position and a retracted position, thus moving a power tool (e.g., the example power drill 100 of FIG. 1) toward and away from a work surface. In particular, the example actuator 1300 includes an actuator bracket 1302, an actuator lever 1304, a one-point hinge 1306, and a multi-point hinge 1308 that includes an extension bracket 1310, all of which are coupled as shown.

The actuator bracket 1302 is mechanically coupled to a base 1312, which is substantially similar or identical to the first elongated member 216a of FIG. 2. The actuator bracket 1302 remains in a fixed position relative to the base 1312 during operation.

The actuator lever 1304 is pivotally coupled to the actuator bracket 1302 via a screw 1314 to form the one-point hinge 1306. In particular, the screw 1314 functions as a fulcrum for rotation of the actuator lever 1304 relative to the actuator bracket 1302. The actuator lever 1304 extends beyond the one-point hinge 1306 and is pivotally coupled to one end of the extension bracket 1310 via a rivet 1316. The rivet 1316 functions as a fulcrum for rotation of the actuator lever 1304 relative to one end of the extension bracket 1310.

The other end of the extension bracket 1310 is pivotally coupled to a movable frame 1318 (which is substantially similar or identical to the movable frame 204) via a screw 1320. The screw 1320 functions as a fulcrum for rotation of the extension bracket 1310 relative to the movable frame 1318. The extension bracket 1310 and the fulcrums defined by the rivet 1316 and the screw 1320 define the multi-point hinge 1308. The one-point hinge 1306 and the multi-point hinge 1308 are used in combination to allow a greater range of rotation and a fluid movement of the movable frame 1318 between an extended position and a retracted position when the actuator lever 1304 is actuated (e.g., swung out or swung in).

During operation, as the actuator lever 1304 is actuated by, for example, an operator in a direction generally indicated by arrow 1322, the one-point hinge 1306 causes the actuator lever 1304 to pivot. The actuator lever 1304 then causes the multi-point hinge 1308 to engage the movable frame in a direction generally indicated by arrow 1324. The arrow 1324 points in a direction that is substantially away from a support surface (e.g., a floor) and substantially toward a work surface. The multi-point hinge 1308 the causes the movable frame 1318 to translate toward an extended position in a direction generally indicated by the arrow 1324. In this manner, the example power drill 100 (FIG. 1) is moved toward and may engage a work surface.

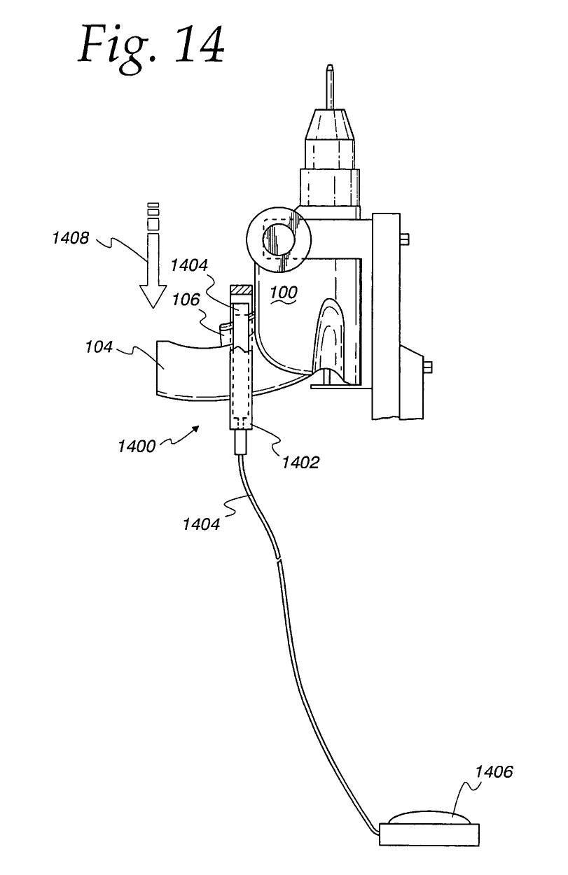

FIG. 14 illustrates an elevational view of an example trigger actuator 1400 that may be used with any of the example inverted drill presses 200, 300, 400, and 500 of FIGS. 2 through 5. The example trigger actuator 1400 is shown in combination with the example power drill 100, which is fastened to an example tool fixture 1402 that is substantially similar or identical to the tool fixture 202 of FIG. 2. The example tool fixture 1402 may be implemented using any of the example tool fixtures 600, 700, and 800 described above in connection with FIGS. 6, 7, and 8. The trigger actuator 1400 may be used to remotely actuate the trigger 106 of the example power drill 100.

The example trigger actuator 1400 includes a frame 1402, a triggering element 1404 located within the frame 1402, a cord 1404, and a remote trigger 1406. The frame 1402 may be mechanically coupled to the handle 104 and around the trigger 106 of the example power drill 100. The frame 1402 may be fastened to the handle 104 via any suitable fastening means (e.g., clamps, screws, etc.). In addition, the triggering element 1404 is assembled within the frame 1402 and is configured to engage the trigger 106. The triggering element 1404 is configured to actuate the trigger 106 in response to stimulus caused by the remote trigger 1406.

The example trigger actuator 1400 may be implemented using, for example, a pneumatic actuation system, an electric actuation system, a retraction cable actuation system, a hydraulic actuation system, an air-piston actuation system, etc. The remote trigger 1406 may be hand operated or foot operated and may be fastened or mechanically coupled to an inverted drill press (e.g., the example inverted drill presses 200, 300, 400, and 500 of FIGS. 2-5). An operator may depress the remote trigger 1406, which causes a stimulus (e.g., electricity, hydraulic pressure, air pressure, cable retraction, etc.) to travel via the cord 1404 to the triggering element 1404. The triggering element 1404 then moves in a direction generally indicated by arrow 1408 to engage and/or depress the trigger 106, thus powering the example power drill 100.

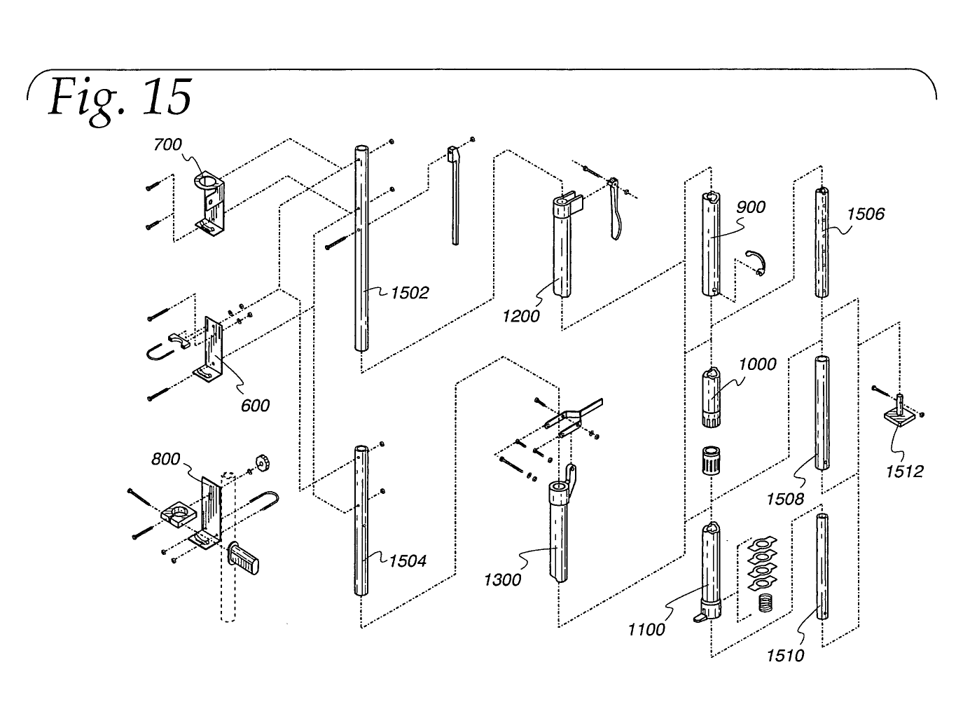

FIG. 15 illustrates an exploded isometric view of various example assembly configurations 1500 that may be used to assemble any of the example inverted drill presses 200, 300, 400, and 500 of FIGS. 2 through 5. In particular, the assembly configurations 1500 include the example tool fixtures 600, 700, and 800 of FIGS. 6, 7, and 8, the example height adjustment apparatus 900, 1000, and 1100 of FIGS. 9, 10, and 11, and the example actuators 1200 and 1300 of FIGS. 12A, 12B, 12C, and 13. In general, the assembly configurations 1500 illustrate how the various parts of an example inverted drill press may be assembled in relation to one another. FIG. 15 shows various parts including a first moveable frame 1502, a second movable frame 1504, the example actuators 1200 and 1300, the height adjustment apparatus 900, 1000, and 1100, a first lower base portion 1506 (e.g., the first tube 906 of FIG. 9B), a second lower base portion 1508 (e.g., the first tube 1004 of FIG. 10B), a third lower base portion 1510 (e.g. the first tube 1106 of FIG. 11B), and a support pad 1512 that is substantially similar to the support pad 218 of FIG. 2.

Several of the parts of FIG. 15 are interchangeable with one another to form an inverted drill press. However, some parts are not interchangeable. In particular, the first moveable frame 1502 is always assembled with the actuator 1200 and the second moveable frame 1504 is always assembled with the actuator 1300. In addition, the height adjustment apparatus 900 is always assembled with the first lower base portion 1506, the height adjustment apparatus 1000 is always assembled with the second lower base portion 1508, and the height adjustment apparatus 1100 is always assembled with the third lower base portion 1510.

In one example implementation, the example tool fixture 600 may be coupled to the first movable frame 1502, which is coupled with the example actuator 1200 to form an upper assembly. The upper assembly may then be coupled to or integrally formed with the height adjustment apparatus 900. In an alternative configuration, the upper assembly may be coupled to or integrally formed with the height adjustment apparatus 1000. Yet in another alternative configuration, the upper assembly may be coupled to or integrally formed with the height adjustment apparatus 1100. Although the upper assembly includes the tool fixture 600, in alternative configurations, the tool fixture 700 or the tool fixture 800 may be coupled to the first movable frame 1502 to form the upper assembly.

In another example implementation, the example tool fixture 600 may be coupled to the second movable frame 1504, which is coupled to the example actuator 1300 to form an alternate upper assembly. The alternate upper assembly may then be coupled to or integrally formed with the height adjustment apparatus 900. In an alternative configuration, the alternate upper assembly may be coupled to or integrally formed with the height adjustment apparatus 1000. Yet in another alternative configuration, the alternate upper assembly may be coupled to or integrally formed with the height adjustment apparatus 1100. Although the alternate upper assembly includes the tool fixture 600, in alternative configurations, the tool fixture 700 or the tool fixture 800 may be coupled to the second movable frame 1504 to form the alternate upper assembly.

Each of the lower base portions 1506, 1508, and 1510 may be pivotally coupled to the support pad 218 as shown more clearly in FIGS. 9, 10, and 11, respectively.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A power tool holding apparatus, comprising:
a frame;
a tool support mechanically coupled to the frame and configured to support a power tool; and
a base mechanically coupled to the frame, wherein a tool piece end of the power tool is configured to move in a direction that is substantially opposite the base to engage a work surface during operation.

2. A power tool holding apparatus as defined in claim 1, further comprising a tool fastener mechanically coupled to the tool support and configurable to fasten the power tool to the tool support.

3. A power tool holding apparatus as defined in claim 1, further comprising an actuator coupled to the frame and the base and configured to adjust a translational direction of the tool support element during operation of the power tool.

4. A power tool holding apparatus as defined in claim 3, wherein the actuator is at least one of a lever and hinge assembly and a rack and pinion assembly.

5. A power tool holding apparatus as defined in claim 1, further comprising a trigger actuator configured to engage a trigger of the power tool.

6. A power tool holding apparatus as defined in claim 5, wherein the trigger actuator is associated with at least one of a pneumatic actuation system, an electric actuation system, a retraction cable actuation system, a hydraulic actuation system, and an air-piston actuation system.

7. A power tool holding apparatus as defined in claim 1, wherein the tool support is configurable to translate in a substantially upward direction to move the cutting end of the power tool toward a work surface.

8. A power tool holding apparatus as defined in claim 1, wherein the power tool is a handheld drill.

9. A power tool holding apparatus as defined in claim 1, wherein the base includes a first elongated member and a second elongated member, and wherein the first elongated member and the second elongated member are arranged in a telescoping configuration.

10. A power tool holding apparatus as defined in claim 9, wherein the position of the first elongated member is adjustable relative to the position of the second elongated member.

11. A power tool holding apparatus as defined in claim 10, wherein the position of the first elongated member is adjustable relative to the position of the second elongated member based on at least one of a clevis pin, a twist-lock fastener, and a slip-grip disk fastener.

12. A power tool actuating apparatus, comprising:
a tool holder configured to be fastened to a power tool;
a movable elongated member mechanically coupled to the tool holder and configured to move from a retracted position to an extended position; and
a substantially stationary support slidably coupled to the movable elongated member and configured to provide support for the movable elongated member, wherein the tool holder is configured to move a direction that is substantially opposite the stationary support to drive a tool piece end of a power tool toward a work surface.

13. A power tool actuating apparatus as defined in claim 12, wherein the power tool is a handheld power drill.

14. A power tool actuating apparatus as defined in claim 12, further comprising an actuator coupled to the movable elongated member and the substantially stationary support and configured to extend the tool holder away from the substantially stationary support.

15. A power tool actuating apparatus as defined in claim 14, wherein the actuator is at least one of a lever and hinge assembly and a rack and pinion assembly.

16. A power tool actuating apparatus as defined in claim 12, further comprising a trigger actuator configured to depress a trigger of the power tool in response to a remote triggering event.

17. A power tool actuating apparatus as defined in claim 16, wherein the trigger actuator is associated with at least one of a hydraulic actuation system, an electric actuation system, an air-piston actuation system, and a retraction cable actuation system.

18. A power tool actuating apparatus as defined in claim 12, wherein the substantially stationary support member includes a first elongated member and a second elongated member that are assembled in a telescoping assembly.

19. A power tool actuating apparatus as defined in claim 12, wherein the position of the first elongated member is adjustable relative to the position of the second elongated member based on at least one of a clevis pin, a twist-lock fastener, and a slip-grip disk fastener.

20. A power tool support apparatus, comprising:
a support pad;
a base pivotally coupled to the support pad and configured to be adjusted from a first length to a second length;
a movable frame movably coupled to the base and configured to move between a retracted position and an extended position in a direction having coplanar alignment with the base;
a tool fixture mechanically coupled to the movable frame and configured to hold a power tool; and
an actuator mechanically coupled to the movable frame and the base and configured to translate the movable frame between the retracted position and the extended position.

21. A power tool support apparatus as defined in claim 20, wherein the actuator is at least one of a lever and hinge assembly and a rack and pinion assembly.

22. A power tool support apparatus as defined in claim 20, wherein the power tool is a handheld power drill.

23. A power tool support apparatus as defined in claim 20, wherein the tool fixture is configured to hold the power tool so that the bit end of the power tool is held in a substantially upward direction.

24. A power tool support apparatus as defined in claim 20, wherein the base includes a first elongated member and a second elongated member, and wherein the first elongated member and the second elongated member are arranged in a telescoping configuration.

25. A power tool support apparatus as defined in claim 24, wherein the position of the first elongated member is adjustable relative to the position of the second elongated member based on at least one of a clevis pin, a twist-lock fastener, and a slip-grip disk fastener.

26. A power tool support apparatus as defined in claim 20, further comprising a trigger actuator configured to engage a trigger of the power tool.

27. A power tool support apparatus as defined in claim 26, wherein the trigger actuator is associated with at least one of a pneumatic actuation system, an electric actuation system, a retraction cable actuation system, a hydraulic actuation system, and an air-piston actuation system.

28. A method for actuating a power tool, the method comprising:
actuating an actuator lever;
engaging a movable frame in a direction substantially toward a work surface and substantially opposite a support surface;
moving the movable frame in a direction that is substantially opposite the support surface and toward the work surface; and
engaging the work surface with a power tool that is fastened to the movable frame.

29. A method as defined in claim 28, wherein engaging the movable frame includes engaging a pinion to a rack.

30. A method as defined in claim 28, wherein engaging the movable frame includes engaging a hinge to the movable frame.

31. A method as defined in claim 28, wherein the power tool is a power drill.

32. A method as defined in claim 28, wherein engaging the work surface with a power tool includes at least one of drilling into a work surface, cutting into a work surface, and fastening onto a work surface.
